(19) United States
(12) Patent Application Publication
(10) Pub. No.: US 2010/0226252 A1
(43) Pub. Date: Sep. 9, 2010

(54) INVOKING DATA SERVICE PRIORITY DURING NETWORK CONGESTION

(75) Inventors: Aleksandar M. Gogic, San Diego, CA (US); Arungundram C. Mahendran, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/713,912

(22) Filed: Feb. 26, 2010

Related U.S. Application Data
(60) Provisional application No. 61/157,121, filed on Mar. 3, 2009.

(51) Int. Cl. H04L 1/00

(52) U.S. Cl. 370/236

(57) ABSTRACT

A method for requesting and providing on-demand priority to internet protocol (IP) flows is disclosed. A request to invoke transmission priority is received. Whether to mark a priority invocation packet for an IP flow with a priority Differentiated Services Code Point (DSCP) marking is determined The priority invocation packet is marked based on the determination and sent. A priority invocation packet for an IP flow that has a priority DSCP marking is received from a wireless device. The priority invocation packet is sent to its destination. Transmission priority is provided to IP flows received from the wireless device or sent to the wireless device for a period of time or until an indication of failed authorization is received.

### RELATED APPLICATIONS

This application is related to and claims priority from U.S. Provisional Patent Application Ser. No. 61/157,121, filed Mar. 3, 2009, for “Systems and Methods for Invoking Data Service Priority During Network Congestion,” the disclosure of which is expressly incorporated by reference herein in its entirety.

### TECHNICAL FIELD

The present disclosure relates generally to communication systems. More specifically, the present disclosure relates to invoking data service priority during network congestion.

### BACKGROUND

Wireless communication systems have become an important means by which many people worldwide have come to communicate. A wireless communication system may provide communication for a number of wireless communication devices, each of which may be serviced by a base station. A wireless communication device may be capable of using multiple protocols and operating at multiple frequencies to communicate in multiple wireless communication systems.

When large amounts of calls are attempted in a wireless communication system, network congestion may occur. This may result in blocked calls, delayed calls, or both. However, some calls may be particularly important and should be given priority during congestion. For example, it may be desirable to give priority to calls from personnel providing emergency services during a natural disaster. Therefore, benefits may be realized by improved systems and methods for invoking data service priority during network congestion.

### BRIEF DESCRIPTION OF THE DRAWINGS

FIG. 1 is a block diagram illustrating a wireless communication system in which the methods and apparatus disclosed herein may be utilized;

FIG. 2 is a block diagram illustrating the functions of a Proxy Call/Session Control Function;

FIG. 3 is a block diagram illustrating two network domains that interface with each other;

FIG. 4 is a block diagram illustrating queuing;

FIG. 5 is a block diagram illustrating multiple levels of priority within a single delay tolerance class;

FIG. 6 is a block diagram illustrating a system for providing on-demand priority to IP flows;

FIG. 7 is a flow diagram illustrating a method for requesting priority in user equipment;

FIG. 8 is a flow diagram illustrating a method for enabling priority invocation for IP flows; and

FIG. 9 illustrates certain components that may be included within a wireless device.

### DETAILED DESCRIPTION

A method for requesting on-demand priority for internet protocol (IP) flows is disclosed. A request to invoke transmission priority is received. It is determined whether to mark a priority invocation packet for an IP flow with a priority Differentiated Services Code Point (DSCP) marking. The priority invocation packet is marked based on the determination. The outgoing packet is sent.

The request to invoke transmission priority may be generated based on user input. The determination of whether to mark the priority invocation packet may include determining to mark priority invocation packets for all IP flows, only browser-generated IP flows, or only an IP flow directed to certain universal resource locator(s) (URL(s)). More packets for the IP flow that are not marked with a priority DSCP marking may be sent.

An apparatus for requesting on-demand priority for IP flows is also disclosed. The apparatus includes a processor and memory in electronic communication with the processor. Executable instructions are stored in the memory. The instructions are executable to receive a request to invoke transmission priority. The instructions are also executable to determine whether to mark a priority invocation packet for an IP flow with a priority Differentiated Services Code Point (DSCP) marking. The instructions are also executable to mark the priority invocation packet based on the determination. The instructions are also executable to send the outgoing packet.

An apparatus for requesting on-demand priority for IP flows is also disclosed. The apparatus includes means for receiving a request to invoke transmission priority. The apparatus also includes means for determining whether to mark a priority invocation packet for an IP flow with a priority Differentiated Services Code Point (DSCP) marking. The apparatus also includes means for marking the priority invocation packet based on the determination. The apparatus also includes means for sending the outgoing packet.

A computer-program product for requesting on-demand priority for IP flows is also disclosed. The computer-program product includes a computer-readable medium having instructions thereon. The instructions include code for receiving a request to invoke transmission priority. The instructions also include code for determining whether to mark a priority invocation packet for an IP flow with a priority Differentiated Services Code Point (DSCP) marking. The instructions also include code for marking the priority invocation packet based on the determination. The instructions also include code for sending the outgoing packet.

A method for providing on-demand priority to internet protocol (IP) flows is disclosed. A priority invocation packet for an IP flow that has a priority DSCP marking is received from a wireless device. The priority invocation packet is sent to its destination. Transmission priority is provided to subsequent packets in all IP flows received from the wireless device or sent to the wireless device for a period of time or until an indication of failed authorization is received.

The priority packets may be arranged and related to other packets so that the packets have a lower probability of being blocked than the other packets. An authorization server may be contacted to determine if the IP flow is authorized based on subscription data about the wireless device. The authorization server may be a Home Subscriber System (HSS) server or a Government Emergency Telecommunications Service (GETS) server. The subsequent packets that are given priority may not have priority DSCP markings.

An apparatus for providing on-demand priority to IP flows is also disclosed. The apparatus includes a processor and memory in electronic communication with the processor. Executable instructions are stored in the memory. The instructions are executable to receive from a wireless device a priority invocation packet for an IP flow that has a priority Differentiated Services Code Point (DSCP) marking. The instructions are also executable to send the priority invocation packet to its destination. The instructions are also executable to provide transmission priority to subsequent packets in all IP flows received from the wireless device or sent to the wireless device for a period of time or until an indication of failed authorization is received.

An apparatus for providing on-demand priority to IP flows is also disclosed. The apparatus includes means for receiving from a wireless device a priority invocation packet for an IP flow that has a priority Differentiated Services Code Point (DSCP) marking. The apparatus also includes means for sending the priority invocation packet to its destination. The apparatus also includes means for providing transmission priority to subsequent packets in all IP flows received from the wireless device or sent to the wireless device for a period of time or until an indication of failed authorization is received.

A computer-program product for providing on-demand priority to IP flows is also disclosed. The computer-program product includes a computer-readable medium having instructions thereon. The instructions include code for receiving from a wireless device a priority invocation packet for an IP flow that has a priority Differentiated Services Code Point (DSCP) marking. The instructions also include code for sending the priority invocation packet to its destination. The instructions also include code for providing transmission priority to subsequent packets in all IP flows received from the wireless device or sent to the wireless device for a period of time or until an indication of failed authorization is received.

When coping with natural and man-made disasters, telecommunication networks may allow emergency assistance personnel, such as police and fire fighters, priority access to the networks. At such times, telecommunication networks in the affected area may be strained by excessive traffic load, and sometimes by impairments to the infrastructure. To enable emergency assistance personnel unimpeded access to the network, priority access may be provided to authorized personnel during emergencies. The services offered to emergency assistance personnel in next generation networks include real-time services such as voice over internet protocol (VoIP) and video conferencing. Other services offered by networks to emergency responders may include non-real-time multimedia services, e.g. downloading emergency escape route information, accessing websites for weather data or vehicular traffic flow data, sending and receiving email, etc. Priority access may be authorized on a temporary or permanent basis. Authorization for priority access may be reflected in priority subscription for a device such as a cell phone or lap-top computer equipped for wireless broadband access. However, priority access may be allowed only if specifically and deliberately invoked by the user. Prior to such invocation, priority access may be denied.

This may result in unfortunate results. One of the purposes of priority invocation is to convey a priority request to the relevant network elements, so that they can treat subsequent communication to and from this device with priority. However, when the user invokes access priority, the network may already be experiencing congestion due to the natural disaster or other event. Thus, an access priority request may itself be blocked.

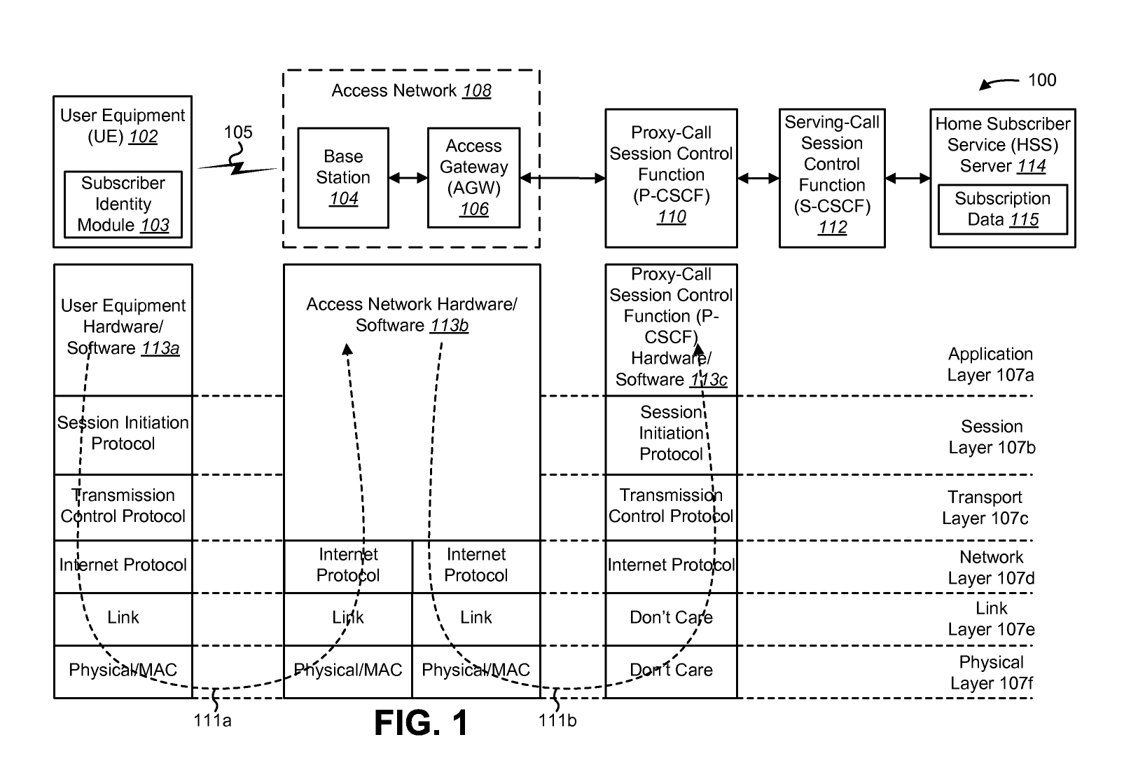

FIG. 1 is a block diagram illustrating a wireless communication system 100 in which the methods and apparatus disclosed herein may be utilized. The system 100 may operate according to the IP Multimedia Subsystem (IMS) to deliver internet protocol (IP) multimedia services to users. The system 100 may include multiple base stations 104 and various pieces of user equipment (UE) 102. Each base station 104 may be part of an access network 108 and may communicate with any user equipment 102 in a geographic area.

Different user equipment 102 may be dispersed throughout the system 100. The user equipment 102 may communicate with zero, one, or multiple base stations 104 on the downlink and/or uplink at any given moment. For example, the user equipment 102 may communicate with the base station 104 using a wireless link 105. The user equipment 102 may be any electronic device capable of sending and receiving IP data, e.g., smartphone, PDA, laptop, etc.

The user equipment 102 may alternatively be referred to as an access terminal, a mobile terminal, a mobile station, a remote station, a user terminal, a terminal, a subscriber unit, a mobile device, a wireless device, a subscriber station, a wireless communication device, or some other similar terminology. The base station 104 may alternatively be referred to as an access point, a Node B, an evolved Node B, a radio transceiver, or some other similar terminology.

The access network 108 may also include an access gateway (AGW) 106, e.g., a packet data serving node (PDSN) or a serving GPRS support node (SGSN) depending on the access network 108. Additionally, the access network 108 may also include intermediary access points, e.g., base station controller, etc.

The system 100 may use layered communication according to the Open System Interconnection (OSI) reference model. Therefore, the system 100 architecture may be divided into layers 107, (i.e., application layer 107a, session layer 107b, transport layer 107c, network layer 107d, link layer 107e, and physical layer 107f), where each layer 107 is a grouping of similar functions that communicate with adjacent layers 107.

The system 100 may also include a Proxy Call/Session Control Function (P-CSCF) 110 that may be implemented in one or more servers. The P-CSCF 110 may be responsible for call attempt processing and allocating resources in the access network 108 for session-based IP services. In other words, the P-CSCF 110 may be responsible to ensure that session initiation protocol invites (SIP INVITE) from priority users are not dropped. Furthermore, in response to a priority call attempt, the P-CSCF 110 may be responsible for queuing up resources in the access network 108 and seizing those resources when released from other calls.

The system 100 may also include a Serving Call/Session Control Function (S-CSCF) 112 that may be responsible for interfacing with a Home Subscriber Server (HSS) 114. The HSS server 114 may include user profiles and perform authentication and authorization of the user. In this way, an SIP INVITE from the user equipment 102 including a priority request may be authenticated and authorized as coming from a legitimate priority user. Alternatively, authorization enforcement may be implemented in the S-CSCF 112.

In the present systems and methods, authentication and authorization may not be the same thing, but may occur together. Authorization, (i.e. verification that an operation is authorized for a particular user), may determine whether the user is subscribed to a particular operation. Authentication may verify the identity of the user. If a user impersonates someone else, authorization may be manipulated. Thus, authentication and authorization may be intertwined, as well as accounting, since the system 100 may charge users for these services. Accounting for service use may be performed so that a user may be billed later. Using a single server to perform the AAA functions may be more efficient.

However, a problem may arise in the system 100 for priority calls during heavy call congestion. Since priority must be granted only when requested by the user, the priority request itself may be blocked or delayed due to congestion. As illustrated in the lower portion of FIG. 1, the system 100 elements may operate with a layered protocol structure, i.e., each system 100 element may recognize certain protocol layers, but not others. In other words, the hardware/software blocks 113 below each network element may illustrate the protocol layers used by the system 100 elements directly above them. Since each element may operate on different protocol layers, an SIP INVITE is not recognized by intervening network elements until it reaches the P-CSCF 110 because of layering, since these intervening elements are not designed to be aware of the SIP layer. However, due to congestion, the very request for priority included in the SIP INVITE may not reach the P-CSCF 110.

As illustrated by the first signaling flow 111a, an SIP INVITE message originated by the user equipment hardware/software 113a may use the transmission control protocol (TCP) to transport to its destination. This may require a transport layer acknowledgment (ACK) from the receiver. The transmission control protocol (TCP) packet may be placed into an IP datagram by the user equipment hardware/software 113a for routing to its destination, e.g., P-CSCF 110. This IP datagram may then be wrapped into a (radio) link layer message that may require a link layer ACK from the (radio) receiver at the other end of the link segment in question. The link layer message may then be wrapped into a (radio) physical layer packet that is multiplexed and transmitted over the access medium where it may be received by the access network hardware/software 113b. The problem may be that the access network hardware/software 113b may not recognize the SIP layer, so the access gateway 106 may not look in the SIP INVITE message to determine that it should be given priority. Additionally, any other transport elements, e.g. routers, between the access network 108 and the P-CSCF 110 may recognize transmission control protocol (TCP), user datagram protocol (UDP), and internet protocol (IP), but not session initiation protocol (SIP).

As illustrated by the second signaling flow 111b, the access network hardware/software 113b may forward the SIP INVITE message to the P-CSCF hardware/software 113c in a similar fashion. The access network hardware/software 113b may receive a TCP/IP datagram that includes the original SIP INVITE message and wrap it into a link layer message (e.g., using fiber distributed data interface (FDDI) protocol). The link layer message may then be wrapped into a physical layer packet (e.g., using synchronous optical networking (SONET) protocol) that is multiplexed and forwarded towards its destination. All access network 108 elements may act on the IP layer, but not on layers above that, and therefore, may not recognize priority indicated in the SIP level. The first SIP aware element may be the P-CSCF 110. Thus, since messages are normally processed by the access network 108 in a first-come-first-served fashion, the system elements preceding the P-CSCF 110, (e.g., the base station 104 and the access gateway 106), may process the SIP INVITE according to default rules, regardless of priority. Thus, during times of congestion, the SIP INVITE may never reach the P-CSCF 110, and may result in a failed flow initialization attempt, i.e., the request for priority itself may not be given priority.

However, if the SIP INVITE message reaches the P-CSCF 110, it may be given priority, at least temporarily while the serving-call session control function 112 consults the HHS server 114. If the user equipment 102 originating the SIP INVITE message is a legitimate user based on subscription data 115 in the HHS server 114, the flow may be given priority. In other words, the SIP INVITE may be given priority by the P-CSCF 110, whether legitimate or not, while data in the subscriber identity module 103 is compared to the subscription data 115. This “legitimacy check” may be a part of a routine authentication that may be done on every call if it is to be billed. Alternatively, authorization enforcement may be implemented by the P-CSCF 110, rather than by the serving-call session control function 112.

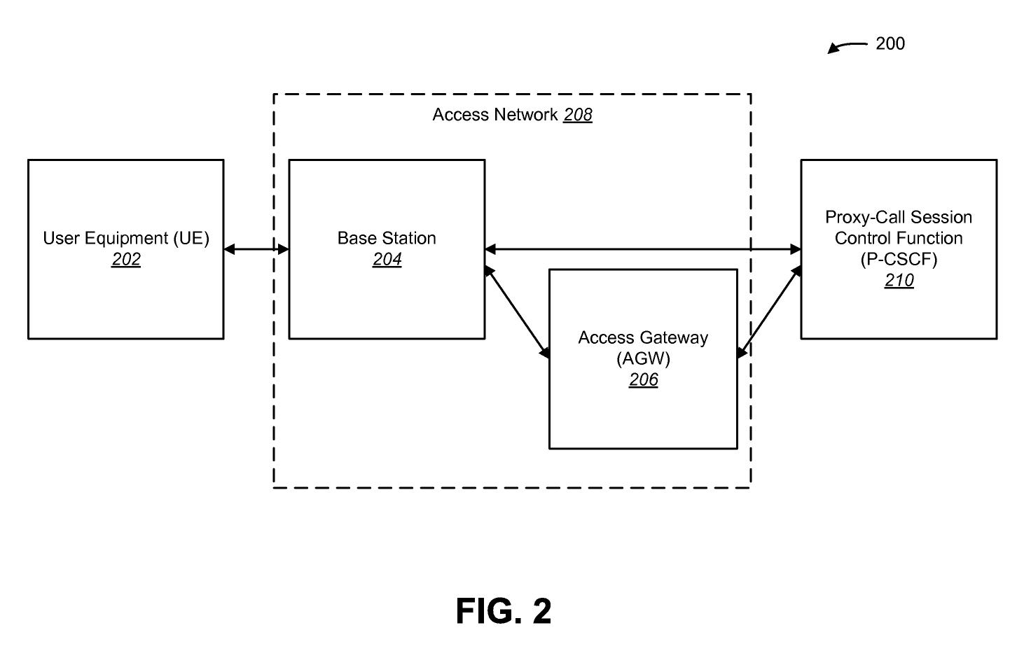

FIG. 2 is a block diagram illustrating the functions of a Proxy Call/Session Control Function 210. The P-CSCF 210 may be required to communicate with an access gateway 206, a base station 204, and other nodes to reserve resources and convey priority for a call or other IMS service. In other words, the P-CSCF 210 may reserve radio resources in the base station 204 and convey priority to the base station 204 (since the base station 204 itself may not recognize a priority indication in the SIP layer), i.e., indicate that packets within a particular flow should be given priority. Likewise, the P-CSCF 210 may reserve communication resources in the access gateway 206 and convey priority to the access gateway (since the access gateway 206 itself may not recognize a priority indication in the SIP layer), i.e., indicate that packets within a particular flow should be given priority. In the system 200, non-VoIP traffic from multiple user equipment 202 may compete with voice over internet protocol (VoIP) traffic, also from multiple user equipment 202. Additionally, radio resources may need to be reserved for real-time services over the duration of a real-time call. This is because the round-trip delay (sending a packet, receiving negative acknowledge, and re-sending a packet) may be too long for the real-time nature of a service such as VoIP. If access gateway 206 resources are not reserved, (e.g. in the case of elastic data services), priority user transmissions may be scheduled by jumping the queue as will be explained below.

One way to reserve resources in the access network 208 may be to forward the SIP INVITE from the P-CSCF 210 to a destination and wait for a reply from the destination entity. Additionally, the P-CSCF 210 may wait until the flow is authorized before reserving resources. However, in one configuration, the P-CSCF 210 may reserve resources in the access network 208 for the priority flow before receiving a reply to reduce delay.

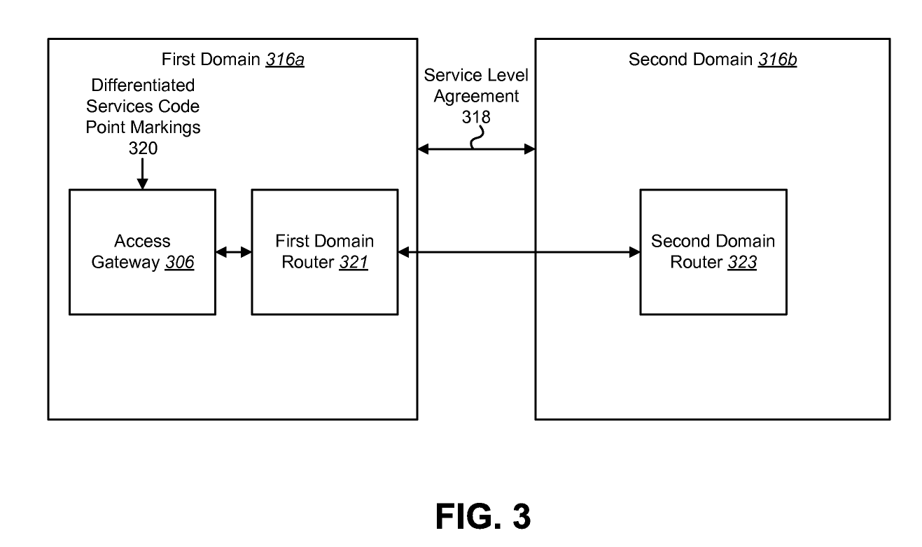

FIG. 3 is a block diagram illustrating two network domains 316 that interface with each other. As used herein, the term “domain” refers to network entities and interconnects that are under the control of a single management entity, such as a wireless network operator or Internet Service Provider. For example, the first domain 316a may be that of a first wireless network operator, while the second domain 316b may be that of a second wireless network operator. The interface 318 between them allows some calls originating in the first domain 316a to be terminated in the second domain 316b, and vice versa. A priority mechanism may exist within each of the two domains 316. The basic mechanism for transport layer service differentiation may be Differentiated Services Code Point (DSCP) as defined by the Internet Engineering Task Force (IETF) in Request for Comments (RFCs) 2474 and 2475. DSCP may differentiate IP packets in transport/routing elements (e.g., routers and switches) according to delay tolerance. However, routers may not be aware of higher layer signaling features, such as SIP, nor do they have flow awareness. In other words, every packet of a flow (a series of packets belonging to a given service connection) must be labeled with DSCP markings appropriate for the service.

DSCP markings 320 may be added by an access gateway 306. However, DSCP does not currently address network congestion, i.e., if the load on a router exceeds its capacity, the router may overflow and discard IP packets for at least some DSCP markings. DSCP markings 320 may work well within a domain 316a to differentiate packets by service, as long as the router does not overflow. However, a service level agreement (SLA) 318 may be needed between domains 316. A service level agreement 318 may be a business relationship that allows mutual billing and other services between a first domain 316a and a second domain 318b. In other words, DSCP markings 320 in packets received from the access gateway 306 may be trusted by a first domain router 321 because they are in the same domain 316, i.e., the markings 320 are followed and not ignored. However, DSCP markings 320 in packets received from the access gateway 306 may not be trusted by a second domain router 323 without a service level agreement 318 because they are in the different domains 316. However, with minor adjustments to existing elements, DSCP markings 320 may be used by user equipment 202 to help the access gateway 306 recognize priority service initiation attempts, such as SIP INVITEs, and give them priority.

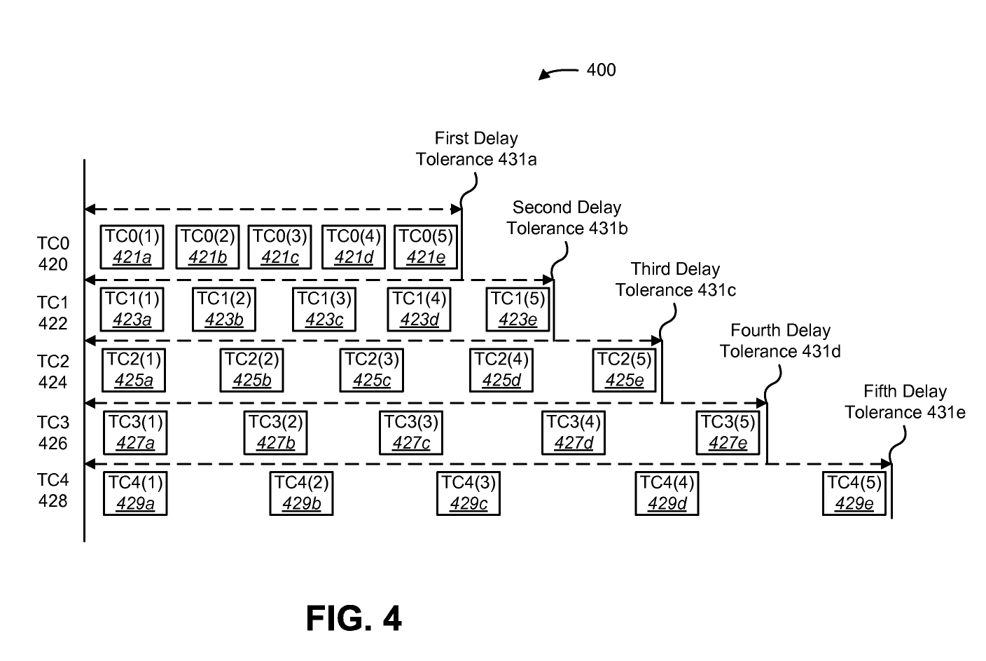

FIG. 4 is a block diagram 400 illustrating queuing. This may be performed, among other places, in an access gateway 106 or a base station 104. Queuing may seek to maximize throughput while maintaining delay commensurate with a given service delay tolerance. FIG. 4 shows packets queued up for transmission, with the horizontal axis representing time. As time goes on, these packets get closer to their transmission time represented by the vertical bar at the left of the figure. Thus, one can symbolically imagine that the time from that vertical bar to the packet lead edge is the total time the packet spent in the queue. However, this is a snapshot. For example, at some point in recent past, the packet 421a was where the packet 421e is shown in figure at the currently depicted snapshot time. Thus, the total time waiting in queue for that packet is less than the delay tolerance 431a. However, if too many packets arrive, the queue would get too long, and packets would exceed their delay tolerance 431.

In FIG. 4, TC0 420 may be flows with a very low delay tolerance, e.g., VoIP. In other words, TC0(1) 421a, TC0(2) 421b, TC0(3) 421c, TC0(4) 421d, and TC0(5) 421e may represent the five flows, each having a first delay tolerance 431a. Likewise, TC1(1) 423a, TC1(2) 423b, TC1(3) 423c, TC1(4) 423d, and TC1(5) 423e may represent the five more flows, each having a second delay tolerance 431b. Likewise, TC2(1) 425a, TC2(2) 425b, TC2(3) 425c, TC2(4) 425d, and TC2(5) 425e may represent the five more flows, each having a third delay tolerance 431c. Likewise, TC3(1) 427a, TC3(2) 427b, TC3(3) 427c, TC3(4) 427d, and TC3(5) 427e may represent the five more flows, each having a fourth delay tolerance 431d. Likewise, TC4(1) 429a, TC4(2) 429b, TC4(3) 429c, TC4(4) 429d, and TC4(5) 429e may represent the five more flows, each having a fifth delay tolerance 431e. The delay tolerances 431 may be progressively longer, i.e., the first delay tolerance 431a may be the shortest and the fifth delay tolerance 431e may be the longest, e.g., the fifth delay tolerance 431e may be associated with Best Effort services, for example for use in a File Transfer Protocol (FTP) flow. To illustrate queuing according to delay tolerance, one possible order of transmission of packets may be TC0(1) 421a, TC4(1) 429a, TC1(1) 423a, TC0(2) 421b, TC3(1) 427a, TC2(1) 425a, TC0(3) 421c, TC1(2) 423b, TC0(4) 421d, TC2(2) 425b, TC4(2) 429b, TC1(3) 423c, TC0(5) 421e, etc.

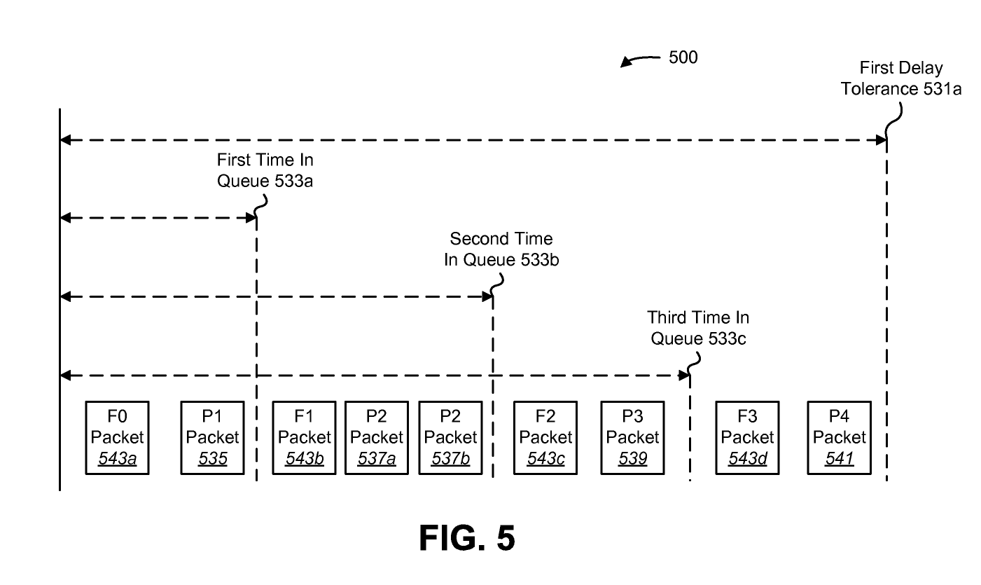

FIG. 5 is a block diagram 500 illustrating multiple levels of priority within a single delay tolerance class. For example, all the packets in FIG. 5 may be associated with multi-media streaming, such as streaming an audio signal. Like queuing, priority placement within a queue may be performed, among other places, in an access gateway 106 or a base station 104. If used, priority may be coordinated with quality of service (QoS). In the block diagram 500, priority packets may be placed in a transmission queue such that estimated queuing delays are commensurate with priority levels. Packets F0 543a, F1 543b, F2 543c, F3 543d may designate different flows, i.e. each is member of a different series of non-priority packets. Packets P1 535, P2 537a-b, P3 539, and P4 541 may represent different priority flows, where each belongs to a priority user of different importance, e.g. President of the United States and his staff for Level 1, all the way down to Federal Emergency Management Agency (FEMA) field operations staff for Level 5.

For purposes of illustration, assume multiple non-priority users and at least two priority users, one at level 1, the other at level 2, are in the same general geographic area affected by a disaster, and there is an audio or video broadcast clip that the users are listening to. Our two priority users may begin to listen to this “broadcast” at different times, but even if they start at exactly the same time, each will produce a series of packets called flows, and these flows will be distinct. Thus, two distinct flows may be produced by two different users even though they receive exactly the same contents. During congestion, packets belonging to ordinary (non-priority) flows F0 543a, F1 543b, F2 543c, F3 543d may be normally placed within their traffic class in the queue in the order in which they arrive, i.e. first-in-first-out (FIFO). But due to congestion, the queue may grow until there is no memory left in the base station 104 hardware. At that point, the base station 104 may start dropping packets. This will start manifesting itself as chopped speech, or freeze-frame video, and depending on severity, may not be understandable or useful for the viewer. In contrast, the priority user level 1 will have packets belonging to its streaming/clipcast flow, (e.g., P1 535), placed well ahead in the queue, so that it does not get dropped and it gets to its destination in a fast and flowless fashion. Priority user of level 2, (e.g., P2 537a) packets will likewise be placed ahead, but the performance may not be as good, i.e., it may have some jerkiness in the video frames, or undesirable speech artifacts. Overall, though, the service will be tolerable, within acceptable bounds of QoS.

Each QoS class may have its own queue placement rules. In one configuration, the priority placement rules for a QoS class may be to place all P0 packets in the front of the queue. Second, place all P1 packets 535 so that the expected queuing delay is less than 15% of the first delay tolerance 531a, i.e., the first time in queue 533a. Third, place all P2 packets 537a-b so that the expected queuing delay is less than 30% of the first delay tolerance 531a, the second time in queue 533b. Fourth, place all P3 packets 539 so that the expected queuing delay is a third time in queue 533c. Additionally, there may be P4 packets 541 that are placed so that the expected queuing delay is a fourth time in queue. Here P0, P1, P2, P3, and P4 designate priority levels, e.g., a P0 user may be more important than a P4 user and thus be given less delay. Non-priority packets, F0-F3 543, may be placed according to their time of arrival, i.e., first-in first-out. Therefore, priority seeks to ensure that there is no (or minimum) outage of service, e.g., blocking is <1%. Furthermore, priority seeks to have no (or few) packets dropped. Both of these goals, though, should be achieved within QoS bounds for the type of service to which the particular flow belongs, e.g., video streaming

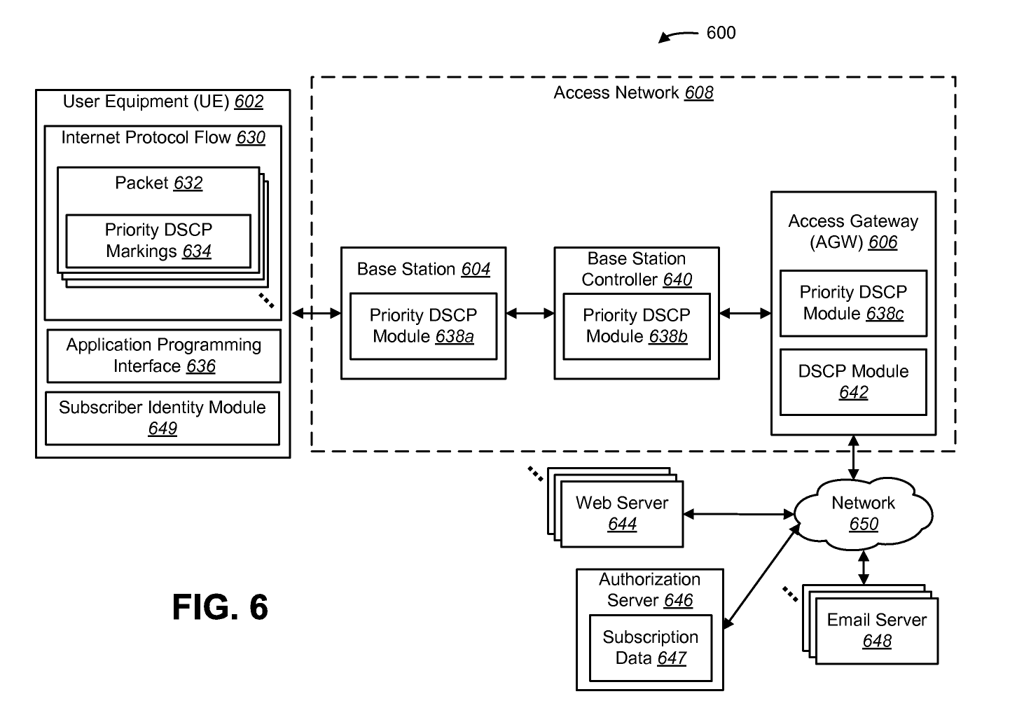

FIG. 6 is a block diagram illustrating a system 600 for providing on-demand priority to IP flows 630. In the system, user equipment 602 may communicate with an access network 608. The access network 608 may include at least one base station 604, base station controller 640, and access gateway 606. The access network 608 may communicate with other networks 650, web servers 644, email servers 648, and authorization servers 646. The network 650 may represent the Internet.

Giving user equipment 602 priority may be closely related to Quality of Service (QoS). In some configurations, packets 632 may be marked with Differentiated Services (Diffserv) Code Points (DSCP) that indicate QoS attributes for the service, e.g., delay tolerance. In a typical use, DSCP markings for outgoing flows 630 (flow originating in the access network 608 and entering the Internet 650) may be affixed to the IP flow 630 in the access gateway 606 in a DSCP module 642. Depending on the type of access network 608 technology, the access gateway 606 may be called a packet data serving node (PDSN) or a serving general packet radio service (GPRS) node (SGSN). Any DSCP markings added by the user equipment 602 may not be trusted because the access network 608 does not have control of the applications being run by the user equipment 602, therefore the access gateway 606 may police DSCP markings, to ensure that the DSCP markings being generated by the user equipment 602 are commensurate with the subscription profile for this user.

In one configuration of the present systems and methods, however, priority invocation IP packets 632 may use specially designated priority DSCP markings 634 inserted by the user equipment 602 that allow access network 608 elements to process these packets 632 with priority en route from the user equipment 602 to the access gateway 606. These priority DSCP markings 634 may use a value currently unreserved in the DSCP protocol. When priority packets 632 with priority DSCP markings 634 start flowing, the access network 608 may verify that packets 632 are originating from user equipment 602 that is subscribed to priority. Only upon successful authentication/authorization may the access gateway allow these packets 632 to proceed, though it may temporarily grant priority to packets while it is performing authentication. Specifically, the access network 608 elements, e.g. base station 604, base station controller 640, and access gateway 606, may give priority to packets 632 with priority DSCP markings 634 until they receive a message from the authorization server 646 indicating otherwise. For example, a packet 632 with priority DSCP markings 634 may be given priority by access network 608 elements while an authorization server 646 authenticates and authorizes the user equipment 602 based on subscription data 647. Furthermore, once an IP flow 630 is identified as a priority flow, subsequent packets 632 from the priority flow may be given priority even if they do not include priority DSCP markings 634. This priority subscription may last for a predetermined period of time or until the flow 630 terminates.

The authorization server 646 may be a Government Emergency Telecommunications Service (GETS) server, a Home Subscriber Service (HSS) server, or any server that is capable of communicating using the Authentication, Accounting, and Authorization (AAA) protocol. For example, the authorization server 646 may be a GETS server and include an AAA server. In this configuration, the GETS server may perform the AAA functions for the user as opposed to performing the functions for the user equipment 602. When the user equipment 602 is activated for a priority user, then the GETS server may not perform the AAA functions, which may be outsourced to a wireless carrier's subscription management (e.g. implemented in HSS). If the user is determined to be illegitimate (authentication or authorization fails based on subscription data 647 in the authorization server 646), the access gateway 606 may discontinue this flow 630 altogether as an enforcement measure.

The priority DSCP markings 634 may be added by an Application Programming Interface (API) 636 that runs in the user equipment 602, which may work as follows. Prior to a congestion-causing event, packets 632 from the user equipment 602 may be treated as though they were originated by any other user. IP packets 632 from the user equipment 602 may not have any DSCP markings, and any such markings may be generated by a DSCP module 642 in the access gateway 606, depending on the type of application that is invoked by the user (the access gateway 606 may be able to determine the type of application based on the port usage, or other means). In other words, the non-priority DSCP markings may be added by the DSCP module 642 to differentiate services to comply with QoS attributes, e.g. delay tolerance. When a user determines that there is network congestion, he/she may activate the API 636 on the user equipment 602 for priority. This may be a flag settable by means of a simple user interface, (e.g., an applet), which, if set, may cause priority DSCP markings 634 to be inserted for traffic generated by this user equipment 602. The API 636 may be downloaded from the access network 608 based on the subscription status of the user equipment 602. In other words, users without priority subscriptions may not have access to the API 636 and may not be able to add priority DSCP markings 634 to packets 632. Downloading the API 636 to the user equipment 602 may be a part of the service provisioning process for the user equipment 602 with priority service subscription. The user interface that accesses the API 636 may be implemented on the user equipment 602 using any suitable technique, e.g., drop-down list, radio button, check box, text box, buttons, etc.

In one configuration, all packets 632 from the user equipment 602 asserting priority are marked with priority DSCP markings 634, which may either be singular, or one for each of multiple traffic classes (may mirror access gateway 606 labeling). Authentication, authorization, or both may occur whenever a new flow 630 is established. Packets 632 may be discontinued by the network upon indication by the authorization server 646 of failed authorization. Packets 632 may be relabeled with different DSCP markings by the access gateway 606, appropriate for the type of service associated with this flow 630.

In another configuration, only browser-generated priority packets 632 may be marked with a singular priority DSCP marking 634. In this configuration, non-browser packets 632 may not be marked with a priority DSCP marking 634 and thus not receive priority in the access network 608. Examples of non-priority packets 632 may be packets 632 directed to web servers 644 or email servers 648. The browser may then allow the user equipment 602 to access an authorization server 646 that allows authentication, authorization, or both, and eventually may result in the priority status for this subscription. Priority status may be valid for a period of time (e.g. as stated in the subscription). Authentication and authorization may include matching subscription data 647 on the authentication server to data in a subscriber identity module 649 in the user equipment 602. An advantage of this approach may be that it requires a single DSCP value be reserved for implementing priority.

In still another configuration, only browser generated flows 630 to a specially designated universal resource locator (URL) may be marked with a singular priority DSCP marking 634. Other flows 630, even browser generated flows to other URLs may not be marked with DSCP markings 634.

Each access network element may include a priority DSCP module 638, i.e., the base station 604 may include a priority DSCP module 638a, the base station controller 640 may include a priority DSCP module 638b, and the access gateway 606 may include a priority DSCP module 638c. The priority DSCP modules 638 may recognize priority DSCP markings 634 and give priority to packets 632 in flows 630 that include the priority DSCP markings 634. This may use existing protocol, e.g., Dynamic Host Configuration Protocol (DHCP) defined by the Internet Engineering Task Force (IETF). In other words, access network elements 608, such as the base station 604 and access gateway 606 may only recognize the internet protocol (IP) layer and lower, but not higher. Since DSCP markings 634 operate at the IP layer, changes to access network elements 608 required to support the present systems and methods may be small or non-existent. Likewise, changes in the user equipment 602 may be minor and may not affect lower protocol layers.

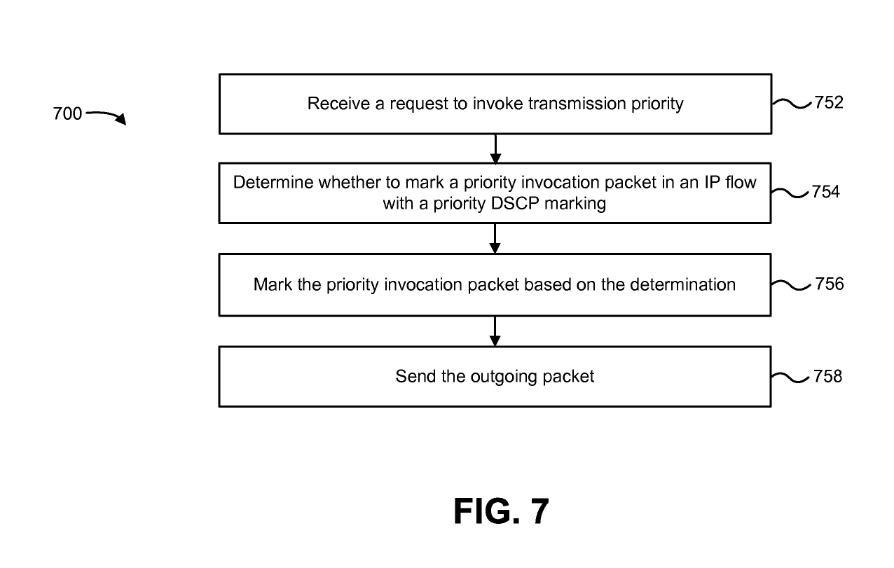

FIG. 7 is a flow diagram illustrating a method 700 for requesting priority in user equipment 602. The user equipment 602 may receive 752 a request to invoke transmission priority. This may be triggered by some user input, e.g., drop down menu, key code, etc., and may be activated in response to network congestion. The user equipment 602 may then determine 754 whether to mark a priority invocation packet 632 in an IP flow 630 with a priority DSCP marking 634. The method 700 may include invoking priority for non-SIP services. The priority invocation packet(s) 632 may be different, depending on the exact protocol used, e.g., Secure Hyper-Text Transport Protocol (HTTPS). For Voice Over Internet Protocol (VOIP), the priority invocation may use a separate mechanism, such as a Resource Priority Header (RPH), for example, and without limitation.

This determination 754 may be made by an API 636 and may account for the source of the flow 630. The user equipment 602 may mark 756 a priority invocation packet 632 in the IP flow 630 based on the determination. For example, the API 636 may mark a priority invocation packet 632 for all types of flows 630, only browser-generated flows 630, or only browser-generated flows 630 to specific URLs. The user equipment 602 may send 758 the priority invocation packet 632 to an access network 608 element, e.g., base station 604. If properly authenticated and authorized, all subsequent IP flows 630 may be given priority even without the priority DSCP marking 634. In other words, Once authorized/authenticated, any flow (not just priority invocation packets) to or from the same user may be given priority since the network elements know that the user is (a) a priority user, and (b) the user has specifically requested and is therefore willing to pay for priority.

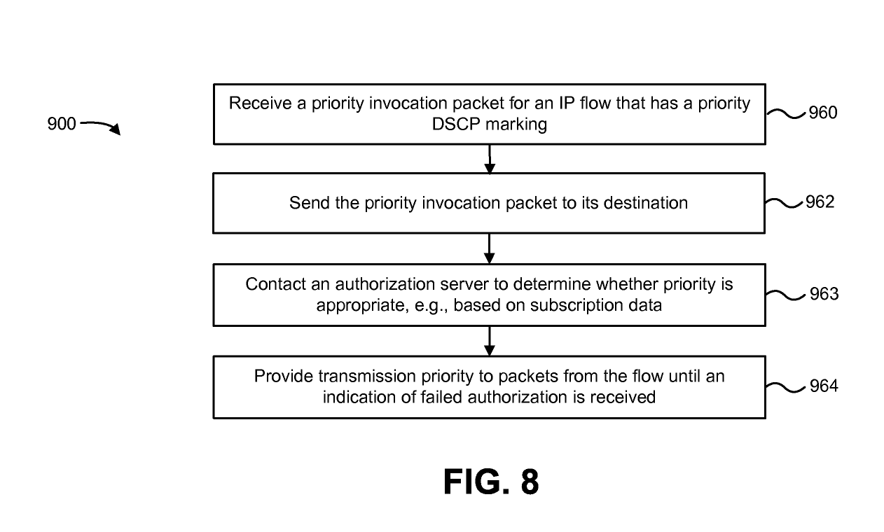

FIG. 8 is a flow diagram illustrating a method 900 for enabling priority invocation for IP flows 630. The method 900 may be performed in an access gateway 606 or other access network 608 elements. The access gateway 606 may receive 960 a priority invocation packet 632 for an IP flow 630 that has a priority DSCP marking 634. The access gateway 606 may send 962 the packet 632 to its destination. The access gateway 606 may contact 963 an authorization server 646 to determine whether priority is appropriate, e.g., based on subscription data 647. The access gateway 606 may also provide 964 transmission priority to packets from all flows to and from this user equipment 602 until an indication of failed authorization is received. In other words, packets 632 with priority DSCP markings 634 may initially be treated with priority by access network 608 elements prior to verifying subscription status of the user equipment 602. However, if the priority authorization conducted by the authorization server 646 based on subscription data 647 fails, the access gateway 606 may then block all further packets 632 for the flow 630.

Therefore, the priority DSCP markings 634 sent from the user equipment 602 may invoke priority for IP flows 630 throughout the system. Once invoked, the priority may apply to some or all IP flows 630 to and from the user equipment 602 from which it was invoked. Thus, one of the functions of the priority DSCP markings 634 is to ensure that all access network 608 elements (e.g. base station 604, base station controller 640, access gateway 606, etc.) are aware of the priority status of this user and that the packets 632 are not dropped due to congestion within the access network 608, including call setup packets, e.g., SIP INVITE messages. This may enable priority communication between the user equipment 602 and the entity that will authorize the validity of the request (e.g. authorization server 646), and in effect instruct all access network 608 elements to obey the priority status of the user equipment 602 for all its IP flows 630. Specifically, the user equipment 602 may use the priority DSCP markings 634 as a bootstrap for unimpeded communication with the authorization server 646 to effectively request priority for all its IP flows 630 for a period of time. This priority invocation may be largely, though not entirely, transparent to a user. For example, a user may activate a drop-down menu and set a priority flag request. However, the user may not be aware of other communication between the user equipment 602 and the authorization server 646 (e.g., HSS) that is labeled with priority DSCP markings 634. Specifically, the user may not be aware of authentication, authorization, or any signaling that reinforces the special treatment of IP flows 630 by the network elements involved.

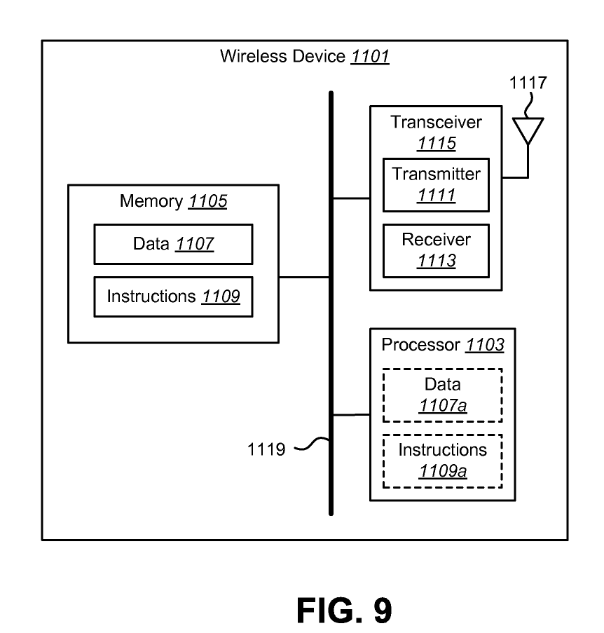

FIG. 9 illustrates certain components that may be included within a wireless device 1101. The wireless device 1101 may be a subscriber station or a base station.

The wireless device 1101 includes a processor 1103. The processor 1103 may be a general purpose single- or multi-chip microprocessor (e.g., an ARM), a special purpose microprocessor (e.g., a digital signal processor (DSP)), a microcontroller, a programmable gate array, etc. The processor 1103 may be referred to as a central processing unit (CPU). Although just a single processor 1103 is shown in the wireless device 1101 of FIG. 11, in an alternative configuration, a combination of processors (e.g., an ARM and DSP) could be used.

The wireless device 1101 also includes memory 1105. The memory 1105 may be any electronic component capable of storing electronic information. The memory 1105 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof

Data 1107 and instructions 1109 may be stored in the memory 1105. The instructions 1109 may be executable by the processor 1103 to implement the methods disclosed herein. Executing the instructions 1109 may involve the use of the data 1107 that is stored in the memory 1105. When the processor 1103 executes the instructions 1109, various portions of the instructions 1109a may be loaded onto the processor 1103, and various pieces of data 1107a may be loaded onto the processor 1103.

The wireless device 1101 may also include a transmitter 1111 and a receiver 1113 to allow transmission and reception of signals between the wireless device 1101 and a remote location. The transmitter 1111 and receiver 1113 may be collectively referred to as a transceiver 1115. An antenna 1117 may be electrically coupled to the transceiver 1115. The wireless device 1101 may also include (not shown) multiple transmitters, multiple receivers, multiple transceivers and/or multiple antenna.

The various components of the wireless device 1101 may be coupled together by one or more buses, which may include a power bus, a control signal bus, a status signal bus, a data bus, etc. For the sake of clarity, the various buses are illustrated in FIG. 11 as a bus system 1119.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 7 and 8, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for requesting on-demand priority for internet protocol (IP) flows, comprising:
receiving a request to invoke transmission priority;
determining whether to mark a priority invocation packet for an IP flow with a priority Differentiated Services Code Point (DSCP) marking;
marking the priority invocation packet based on the determination; and
sending the outgoing packet.

2. The method of claim 1, further comprising generating the request to invoke transmission priority based on user input.

3. The method of claim 1, wherein the determining comprises determining to mark priority invocation packets for all internet protocol (IP) flows.

4. The method of claim 1, wherein the determining comprises determining to mark priority invocation packets for only internet browser-generated internet protocol (IP) flows.

5. The method of claim 4, wherein the determining further comprises determining to mark priority invocation packets for only internet protocol (IP) flows directed to certain universal resource locator(s) (URL(s)).

6. The method of claim 1, further comprising sending more packets for the internet protocol (IP) flow that are not marked with a priority Differentiated Services Code Point (DSCP) marking.

7. An apparatus for requesting on-demand priority for internet protocol (IP) flows, comprising:
a processor;
memory in electronic communication with the processor;
instructions stored in the memory, the instructions being executable by the processor to:
receive a request to invoke transmission priority;
determine whether to mark a priority invocation packet for an IP flow with a priority Differentiated Services Code Point (DSCP) marking;
mark the priority invocation packet based on the determination; and
send the outgoing packet.

8. The apparatus of claim 7, further comprising instructions executable to generate the request based on user input.

9. The apparatus of claim 7, wherein the instructions executable to determine comprise instructions executable to determine to mark priority invocation packets for all internet protocol (IP) flows.

10. The apparatus of claim 7, wherein the instructions executable to determine comprise instructions executable to determine to mark priority invocation packets for only internet browser-generated internet protocol (IP) flows.

11. The apparatus of claim 10, wherein the instructions executable to determine comprise instructions executable to determine to mark priority invocation packets for only internet protocol (IP) flows directed to certain universal resource locator(s) (URL(s)).

12. The apparatus of claim 7, further comprising instructions executable to send more packets for the internet protocol (IP) flow that are not marked with a priority Differentiated Services Code Point (DSCP) marking.

13. An apparatus for requesting on-demand priority for internet protocol (IP) flows, comprising:
means for receiving a request to invoke transmission priority;
means for determining whether to mark a priority invocation packet for an IP flow with a priority Differentiated Services Code Point (DSCP) marking;
means for marking the priority invocation packet based on the determination; and
means for sending the outgoing packet.

14. The apparatus of claim 13, wherein the means for determining comprises means for determining to mark priority invocation packets for all internet protocol (IP) flows.

15. The apparatus of claim 13, wherein the means for determining comprises means for determining to mark priority invocation packets for only internet browser-generated internet protocol (IP) flows.

16. The apparatus of claim 15, wherein the means for determining further comprises means for determining to mark priority invocation packets for only internet protocol (IP) flows directed to certain universal resource locator(s) (URL(s)).

17. A computer-program product for requesting on-demand priority for internet protocol (IP) flows, the computer-program product comprising a computer-readable medium having instructions thereon, the instructions comprising:
code for receiving a request to invoke transmission priority;
code for determining whether to mark a priority invocation packet for an IP flow with a priority Differentiated Services Code Point (DSCP) marking;
code for marking the priority invocation packet based on the determination; and
code for sending the outgoing packet.

18. The computer-program product of claim 17, wherein the code for determining comprises code for determining to mark priority invocation packets for all internet protocol (IP) flows.

19. The computer-program product of claim 17, wherein the code for determining comprises code for determining to mark priority invocation packets for only internet browser-generated internet protocol (IP) flows.

20. The computer-program product of claim 17, wherein the code for determining further comprises code for determining to mark priority invocation packets for only internet protocol (IP) flows directed to certain universal resource locator(s) (URL(s)).

21. A method for providing on-demand priority to internet protocol (IP) flows, comprising:
receiving from a wireless device a priority invocation packet for an IP flow that has a priority Differentiated Services Code Point (DSCP) marking;
sending the priority invocation packet to its destination; and
providing transmission priority to subsequent packets in all IP flows received from the wireless device or sent to the wireless device for a period of time or until an indication of failed authorization is received.

22. The method of claim 21, wherein the providing priority comprises arranging the packets in relation to other packets so that the packets have a lower probability of being blocked than the other packets.

23. The method of claim 21, further comprising contacting an authorization server to determine if the internet protocol (IP) flow is authorized based on subscription data about the wireless device.

24. The method of claim 23, wherein the authorization server is a Home Subscriber System (HSS) server or a Government Emergency Telecommunications Service (GETS) server.

25. The method of claim 21, wherein the subsequent packets do not have a priority Differentiated Services Code Point (DSCP) marking.

26. An apparatus for providing on-demand priority to internet protocol (IP) flows, comprising:
a processor;
memory in electronic communication with the processor;
instructions stored in the memory, the instructions being executable by the processor to:
receive from a wireless device a priority invocation packet for an IP flow that has a priority Differentiated Services Code Point (DSCP) marking;
send the priority invocation packet to its destination; and
provide transmission priority to subsequent packets in all IP flows received from the wireless device or sent to the wireless device for a period of time or until an indication of failed authorization is received.

27. The apparatus of claim 26, wherein the instructions executable to provide priority comprise instructions executable to arrange the packets in relation to other packets so that the packets have a lower probability of being blocked than the other packets.

28. The apparatus of claim 26, further comprising instructions executable to contact an authorization server to determine if the internet protocol (IP) flow is authorized based on subscription data about the wireless device.

29. The apparatus of claim 28, wherein the authorization server is a Home Subscriber System (HSS) server or a Government Emergency Telecommunications Service (GETS) server.

30. The apparatus of claim 26, wherein the subsequent packets do not have a priority Differentiated Services Code Point (DSCP) marking.

31. An apparatus for providing on-demand priority to internet protocol (IP) flows, comprising:
means for receiving from a wireless device a priority invocation packet for an IP flow that has a priority Differentiated Services Code Point (DSCP) marking;
means for sending the priority invocation packet to its destination; and
means for providing transmission priority to subsequent packets in all IP flows received from the wireless device or sent to the wireless device for a period of time or until an indication of failed authorization is received.

32. The apparatus of claim 31, wherein the means for providing priority comprises means for arranging the packets in relation to other packets so that the packets have a lower probability of being blocked than the other packets.

33. The apparatus of claim 31, further comprising means for contacting an authorization server to determine if the internet protocol (IP) flow is authorized based on subscription data about the wireless device.

34. A computer-program product for providing on-demand priority to internet protocol (IP) flows, the computer-program product comprising a computer-readable medium having instructions thereon, the instructions comprising:
code for receiving from a wireless device a priority invocation packet for an IP flow that has a priority Differentiated Services Code Point (DSCP) marking;
code for sending the priority invocation packet to its destination; and
code for providing transmission priority to subsequent packets in all IP flows received from the wireless device or sent to the wireless device for a period of time or until an indication of failed authorization is received.

35. The computer-program product of claim 34, wherein the code for providing priority comprises code for arranging the packets in relation to other packets so that the packets have a lower probability of being blocked than the other packets.

36. The computer-program product of claim 34, further comprising code for contacting an authorization server to determine if the internet protocol (IP) flow is authorized based on subscription data about the wireless device.
